(19) United States
(12) Patent Application Publication
(10) Pub. No.: US 2026/0024004 A1
(43) Pub. Date: Jan. 22, 2026

(54) SYSTEMS AND METHODS FOR USE IN IDENTIFYING HIDDEN BIAS IN DATASETS

(71) Applicant: MASTERCARD TECHNOLOGIES CANADA ULC, VANCOUVER (CA)

(72) Inventors: Arturo Del Valle, Kankakee, IL (US); John Hearty, Vancouver (CA); Wally F. Lo Faro, St. Louis, MO (US)

(21) Appl. No.: 18/775,818

(22) Filed: Jul. 17, 2024

(51) Int. Cl. G06N 20/00

(52) U.S. Cl. CPC G06N 20/00

(57) ABSTRACT

Disclosed are example embodiments of systems and methods for use in identify content included in datasets, independent of certain data being included in the datasets. In an example embodiment, a computer-implemented method generally includes accessing interaction data as a dataset, where the interaction data is representative of multiple network interactions and includes a first variable and a second variable, and appending demographic data to the dataset. The method also includes applying an exponential decay function, based on multiple constants, to the first variable of the dataset, where each of the constants is indicative of a different defined interval, and encoding the second variable of the dataset into multiple columns in the dataset, where each of the multiple columns includes a binary value. The method then includes training a classifier model based on the dataset, where the demographic data defines classification of the interaction data.

### FIELD

The present disclosure generally relates to systems and methods for use in identifying hidden bias in datasets, and in particular, to systems and methods for use in identifying hidden bias in datasets, based on demographics in the datasets representative of network interactions.

### BACKGROUND

This section provides background information related to the present disclosure which is not necessarily prior art.

Users interact with businesses in a variety of different manners. In some instances, users engage in commercial network interactions, where, for example, the users apply for credit cards, transact for the purchase of products (e.g., goods, services, etc.), etc. As a consequence of the interactions, data representative of the interactions is generated and stored in datasets. The datasets are known to be leveraged, with the appropriate permissions, to perform certain types of analysis, from fraud detection to marketing, etc.

### DRAWINGS

The drawings described herein are for illustrative purposes only of selected embodiments and not all possible implementations, and are not intended to limit the scope of the present disclosure.

FIG. 1 is a block diagram of an example system of the present disclosure suitable for use in identifying bias in datasets, independent of certain data being included in the datasets;

FIG. 2 is a block diagram of a computing device that may be used in the example system of FIG. 1; and

FIG. 3 is an example method, which is suitable to be implemented in the system of FIG. 1, and which may be used to identify bias in datasets, independent of certain data being included in the datasets.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Network interactions between users and business occur in various forms, with the network interactions often generating data representing the network interactions, which is limited in content. That is, certain demographic data is absent from the data, based on rules and restrictions. As such, the datasets are limited in analysis of the interaction for the existence, or non-existence, of certain type of hidden bias.

Uniquely, the systems and methods herein provide for identifying bias in datasets representative of network interactions, independent of certain data being included in the datasets. In particular, network interaction data (e.g., transaction data, etc.) for accounts is collected into a dataset including certain data (where the network interaction data is devoid of demographic data). The datasets are formatted into aggregate data representative of interval values for certain data, such as, for example, category codes, product codes, amounts, card present status, etc. The formatted datasets are then joined with demographic data associated with the users of the accounts (e.g., age, gender, race, etc.), as comprehensive, labeled datasets. The datasets are then used to train models, by separating the datasets into training sets and validating sets. When trained and validated, the models are configured to predict demographic data, from the interaction data, whereby bias may be confirmed to exist, or confirmed not to exist. In this manner, network interaction data, which is devoid of demographic, may be used to assess potential bias for certain demographics, through the trained models, yet independent of actual demographic data being comingled with the interaction data representative of the network interactions between users and businesses, etc. Consequently, behavior associated with the network interactions may be changed to ensure fairness, when demographic bias is predicted and actually confirmed.

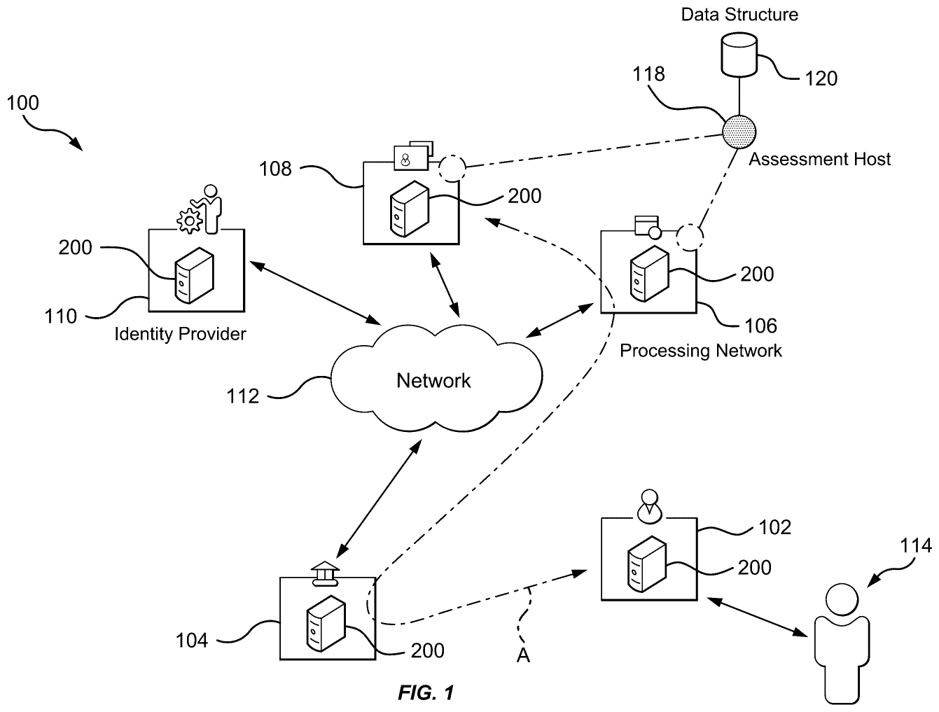

FIG. 1 illustrates an example system 100, in which one or more aspects of the present disclosure may be implemented. Although, in the described embodiment, the system 100 is presented in one arrangement, other embodiments may include the system 100 arranged otherwise depending on, for example, arrangement of entities extending credit to prepaid payment accounts, etc.

As shown in FIG. 1, the system 100 generally includes a merchant 102, an acquirer 104, a processing network 106, an issuer 108, and an identity provider 110, each coupled to (and in communication with) network 112. The network 112 is represented by the cloud, and potentially, the arrowed lines in FIG. 1. The network 112 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof. In one example, the network 112 includes multiple networks, where different ones of the multiple networks are accessible to different ones of the illustrated parts in FIG. 1.

Generally in the system 100, the merchant 102 offers products (e.g., goods, services, etc.) for sale to one or more users, including, for example, a user 114. Then, in connection with a transactions for one or more of the products, the user 114 presents an account, which is issued by the issuer 108, to fund the transaction for the one or more products from the merchant 102. The merchant 102 is configured to capture (e.g., at a point of sale terminal, website, etc.) the account credential for the account (e.g., a primary account number (PAN), expiration date, etc.) and to compile an authorization request, for the transaction. The authorization request includes the transaction amount, the account credential, acquirer identifier, time/date, merchant identifying data (e.g., identifier, location, terminal ID, etc.), etc. The merchant 102 is configured to transmit the authorization request to the acquirer 104, along path A in the system 100.

The acquirer 104 is configured to have issued an account to the merchant 102 to receives funds from the transaction. In response to the authorization request, the acquirer 104 communicates the authorization request to the issuer 108 (associated with the employer prepaid account) along path A through the processing network 106, such as, for example, through MasterCard®, VISA®, Discover®, American Express®, etc. The issuer 108 employs a variety of rules and/or conditions to determine whether the user's account is in good standing and whether sufficient funds and/or credit exist to fund the transaction. If approved, an authorization reply is transmitted back from the issuer 108 to the merchant 102 along path A, thereby permitting the merchant 102 to complete the transaction. The processing network 106 is configured to cooperate with the acquirer 104 and the issuer 108 to clear and settle the transaction (via appropriate transaction messages such as clearing messages and/or settlement messages, for example) (based on appropriate agreements). If the transaction is declined (e.g., for lack of funds in the prepaid payment account, etc.), an authorization reply is provided back to the merchant 102, thereby permitting the merchant 102 to halt or terminate the transaction, or request alternate funding.

Transaction data is generated, collected, and stored as part of the above interactions among the acquirer 104, the processing network 106, and the issuer 108. The transaction data represents the above transaction and many other transactions involving various merchants, acquirers, issuers and users, etc., whether authorized transactions, cleared and/or settled transactions, attempted transactions, etc. The transaction data, in this example embodiment, is stored at least by the processing network 106 (e.g., in a data structure therein, etc.), but could be stored in other parts of the system 100. As used herein, transaction data may include, for example (and without limitation), primary account numbers (PANs) for accounts involved in the transactions, amounts of the transactions, merchant IDs for merchants involved in the transactions, merchant category codes (MCCs), dates/times of the transactions, location data associated with the transactions, etc.

It should be appreciated that more or less information related to transactions, as part of either authorization or clearing and/or settling, may be included in transaction records (comprising transaction data) and stored within the system 100, at the merchant 102, the acquirer 104, the payment network 106 and/or the issuer 108, or elsewhere

With continued reference to FIG. 1, the identity provider 110 may include any party, or entity, which is in possession of identifying data for one or more users, including, for example, a user 114. The identifying data, in this embodiment, includes names, addresses, phone numbers, government identification numbers (e.g., social security numbers, Aadhaar numbers, driver license numbers, passport numbers, etc.), email addresses, etc. In addition, in this example embodiment, the identifying data further includes demographic data, such as, for example, gender, race, ethnicity, age, residence, income, education, etc. In general, the identity provider 110 is separate from the acquirer 104, processing network 106, and the issuer 108, in this example embodiment, but may be included therein, in whole or in part, in other embodiment.

One example identity provider 110 includes a credit bureau, which is configured to collect identifying data and financial related data for users, and to further define a credit score for the users based on the identifying data and other financial related data. The financial related data may include income, payment history, account longevity, account openings, credit usage, credit inquiries, etc.

It should be appreciated that the identifying data may be provided by another suitable entity, which is in possession, through associated permissions, rules, and regulations, of demographic data that is tied to the identity of the user 114 (or financial related data of the user 114) (e.g., through account information, etc.). Other identity providers may include, for example, insurance providers, financial services providers, etc.

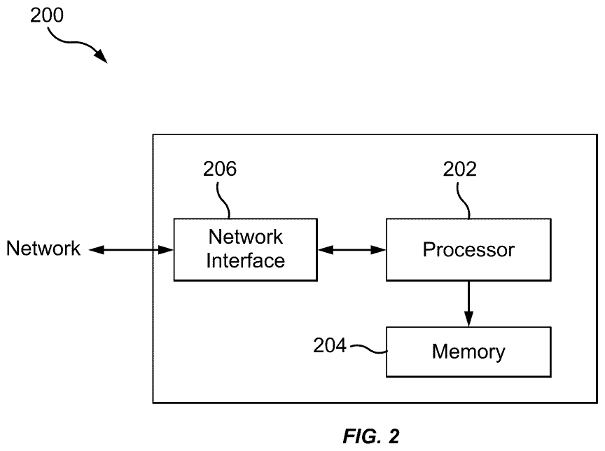

FIG. 2 illustrates an example computing device 200 that can be used in the system 100 of FIG. 1. The computing device 200 may include, for example, one or more servers, workstations, routers, personal computers, tablets, laptops, smartphones, point-of-sale (POS) terminals, etc. In addition, the computing device 200 may include a single computing device, or it may include multiple computing devices located in close proximity or distributed over a geographic region, so long as the computing devices are specifically configured to function as described herein. In the example embodiment of FIG. 1, each of the merchant 102, the acquirer 104, the payment network 106, the issuer 108, and the identity provider 110 are illustrated as including, or being implemented in, a computing device 200, coupled to (and in communication with) the network 112. However, the system 100 (and the parts therein) should not be considered to be limited to the computing device 200, as described below, as different computing devices and/or arrangements of computing devices may be used. In addition, different components and/or arrangements of components may be used in other computing devices.

The example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, interaction data, demographic data, and/or other data structures suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In addition, the illustrated computing device 200 further includes a network interface 206 coupled to (and in communication with) the processor 202 and the memory 204. The network interface 206 may include, without limitation, a wired network adapter, a wireless network adapter, a mobile network adapter, or other device capable of communicating to/with one or more different networks, including the network 112. Further, in some example embodiments, the computing device 200 includes the processor 202 and one or more network interfaces (including the network interface 206) incorporated into or with the processor 202.

Referring again to FIG. 1, the system 100 includes an assessment host 118, which is configured, by executable instructions, to perform one or more operations described herein. The assessment host 118 may be included in a sperate computing device (e.g., consistent with computing device 200, etc.), or integrated, in whole or in part, in the processing network 106, or, potentially, the issuer 108, etc.

The system 100 further includes a data structure 120, which is coupled to the assessment host 118. The data structure 120 may be separate from the assessment host 118, as illustrated in FIG. 1, or may be incorporated and/or included, in whole or in part, therein in other system embodiments. The data structure 120 is generally stored in memory, such as, for example, the memory 204 of the computing device associated with the assessment host 118, etc. In this example embodiment, the data structure 120 includes a variety of the data described above, including, without limitation, interaction data representative of tens of thousands, hundreds of thousands, millions, etc., of interactions related to various users, including the user 104.

In the example embodiment, the assessment host 118 is configured to access network interaction data representative of various network interactions, as a dataset. The data included in the dataset is referred to herein as a variable. As such, the dataset includes values for multiple variables, such as, for example, for each interaction (or transaction): an account number, MCC, a purchase amount, card present, aggregate transaction count (or transaction count aggregate), product code (e.g., indicative of the type of account, etc.), etc. It should be appreciated that the dataset may be reduced, or limited in connection with the access. For example, the assessment host 118 may be configured to preserve certain values for the card present data element in the dataset, but restrict others. For example, card present values of zero, four and five may be preserved, while all others are reduced to “other.” In this way, the number of card present values may be reduced (e.g., to four distinct values, i.e., 0, 4, 5, other), etc. It should also be appreciated that the MCC may be reduced in a similar manner in the dataset, where a percentile of the MCCs are preserved while others are reduced to “other.” For example, the MCC may include 541 different codes, and may be truncated to 95-percentile whereby the resulting MCC includes about 250 categories. It should be appreciated that other data reduction and/or truncation techniques may be employed, here or later in the sequence of operations, for the accessed data, for example, based on the value of the data, memory limitations, etc.

It should be understood that in this example embodiment, the assessment host 118 is configured to access data for the dataset based on a defined interval, which may be the last 30 days, 60 days, 90 days, 120 day, or other suitable defined interval, potentially, based on the volume of data included in the interval, etc. In one or more other embodiments, the interval may be defined otherwise, such as, for example, by date range, season (e.g., holiday season, travel season, etc.), historical spending periods, etc. In this example embodiment, the assessment host 118 may be configured to sample the dataset, randomly or pseudo randomly, to reduce the number of interactions included therein. In general, the sampling is PAN-specific, whereby the interaction data for each PAN is either retained or not, so that all interactions within the defined interval are retained for the retained PAN(s). It should be appreciated that the sampling may be completed with a goal associated with a certain size of the dataset to be retained, such as, for example, a number of gigabytes of data, etc.

The assessment host 118 is further configured to condense the dataset to include one entry for each PAN, such that each entry represents a summary (for the given PAN) with aggregated values, for example, for each MCC, purchase amounts, card present transactions, aggregate transaction counts (or transaction count aggregate), product codes, etc.

An example subset of the data set is shown in Table 1, below, for example, for different account numbers.

TABLE 1

| | | merch_{—} | | | |
|---|---|---|---|---|---|
| | dw_{—} | category_{—} | txn_{—} | dw_net_pd_{—} | cardholder_present_{—} |
| de2_card_nbr | product_cd | cd | count | amt_sum | cd_reduced |
| 5.178059e+18 | MWE | 5999 | 1 | 51.43 | 0 |
| 5.590340e+18 | MDJ | 9399 | 1 | 73.25 | 5 |
| 5.466160e+18 | MCW | 7523 | 2 | 1.61 | 5 |
| 5.592570e+18 | MAB | 5541 | 1 | 9.00 | 0 |
| 5.312580e+18 | MDJ | 5812 | 1 | 20.48 | 5 |

Next, the assessment host 118 is configured to append demographic data. That is, the assessment host 118 is configured to access demographic data, which includes one or more demographics to be appended to the dataset, from the identity provider 110. The demographic may includes, for example, genders of the users (e.g., including the user 114, etc.), which, in turn, are associated with PANs for accounts associated with the users. The assessment host 118 is configured to search for each PAN(s) in the dataset and to append a corresponding gender, for example, to the dataset for the given PAN(s).

It should be appreciated that one or more other demographics may be appended to the dataset, in lieu of or in addition to the gender demographic, in other examples.

In this example embodiment, the assessment host 116 is configured to perform feature engineering on certain data included in the dataset, which, in this example, includes, specifically, the transaction count and the gross dollar value (e.g., variable V, etc.), which corresponds to the sum of the total dollar values of all transactions in/for a PAN. It should be understood that exponential decay, as used here, defines decrease of a variable (e.g., count, gross dollar value, etc.) over time. The exponential decay is characterized by a constant rate, k, which determines speed at which the variable decreases. For an initial value, V₀, for the given/desired variable, V, the value of the specific variable is given when time t is tᵢ for i=1, 2, 3, . . . n, where n corresponds to the number of transactions in/for a given PAN. That said, the variable, V, may be expressed by the formula:

$$V ( t ) = {V}_{0} {e}^{- k \cdot {t}_{0}} + {V}_{1} {e}^{- k \cdot {t}_{1}} + … {V}_{n} {e}^{- k \cdot {t}_{n}}$$

where V₀e^{-k·t}^{₀} is an exponential function representing a number of days past the transaction date, and which is the value of a chosen column of the dataset.

In this specific example, the assessment host 118 is configured to rely on three decay constants to represent different velocities of decay. The constants correspond to, for example, 30, 60, and 90 days, for monthly, bi-monthly, and quarterly velocities, respectively, where the constants are 0.15, 0.075, and 0.005, respectively. By plugging these decay constants into the exponential decay equation, we can model the decay of the selected variables over time with the desired velocity. The assessment host 118 is configured to append the data to the dataset.

It should be appreciated that the above description provides one specific example of feature engineering. The assessment host 118 may be configured to determine other features of the data, in other embodiments, including, without limitation, average transaction value (i.e., mean value of all transactions made by the user), maximum transaction value (i.e., maximum value of all transactions made by the user), number of transactions per day (i.e., average number of transactions made by the user per day), number of unique merchants (i.e., total number of unique merchants where the user has made transactions), most frequent merchant category (i.e., the merchant category where the user makes most frequent transactions), number of entertainment transactions per day (i.e., average number of transactions made by the user per day in entertainment-related merchant categories (e.g., movies, concerts, etc.)), average entertainment transaction value (i.e., mean value of all entertainment-related transactions made by the user), number of travel transactions per day (i.e., average number of transactions made by the user per day in travel-related merchant categories (e.g., airlines, hotels, etc.)), average travel transaction value (i.e., mean value of all travel-related transactions made by the user), most frequent entertainment merchant category (i.e., the entertainment-related merchant category where the user makes most frequent transactions), number of transactions with top merchant per day (i.e., average number of transactions made by the user per day with their most frequently used merchant), average transaction value with top merchant (i.e., mean value of all transactions made by the user with their most frequently used merchant), number of transactions with top merchant category per day (i.e., average number of transactions made by the user per day in their most frequently used merchant category), average transaction value with top merchant category (i.e., mean value of all transactions made by the user in their most frequently used merchant category), proportion of transactions with top merchant (i.e., the ratio of the number of transactions made by the user with their most frequently used merchant to the total number of transactions made by the user), proportion of transaction value with top merchant (i.e., the ratio of the total value of transactions made by the user with their most frequently used merchant to the total value of all transactions made by the user), proportion of transactions with top merchant category (i.e., the ratio of the number of transactions made by the user in their most frequently used merchant category to the total number of transactions made by the user), proportion of transaction value with top merchant category (i.e., the ratio of total value of transactions made by the user in their most frequently used merchant category to total value all transactions made by user), number of online transactions per day (i.e., average number of online transactions made by the user per day), average online transaction value (i.e., mean value of all online transactions made by the user), number of in-store transactions per day (i.e., average number of in-store transactions made by the user per day), average in-store transaction value (i.e., mean value of all in-store transactions made by the user), monthly spending trend (i.e., the change in total spending by the user from month to month), monthly transaction count trend (i.e., the change in the number of transactions made by the user from month to month), most frequent transaction day of week (i.e., the day of the week when the user makes most frequent transactions), most frequent transaction time of day (i.e., the time of day when the user makes most frequent transactions), average monthly cash advance amount (i.e., mean value of all cash advances made by the user per month), median transaction value (i.e., median value of all transactions made by the user), transaction value standard deviation (i.e., standard deviation of the value of all transactions made by the user, etc.

The assessment host 118 is configured to append the additional features, if any, to the dataset.

Next, in this example embodiment, the assessment host 118 is configured to aggregate certain data in the dataset (e.g., as generally described above, and/or generally using the exponential decay function described with regard to variable V; etc.). In particular, the assessment host 118 is configured to group rows together by PAN, and then, to add the associated values for the specific rows, leaving, separately, the product code (or card type), the MCC, and the card present data.

In this example embodiment, the assessment host 118 is configured to convert the dataset to a wide format, through one-hot-encoding. Initially, the assessment host 118 may be configured to further reduce or truncate the data included in the data set. For example, as explained above, certain MCCs may be converted to others, where the incidence of the MCC is below a threshold (e.g., less than a ninety-fifth percentile, etc.). The assessment host 118 is configured to then apply one-hot-encoding to the MCC, the product type and the card present date. In this manner, the dataset includes columns for each associated value of the dataset, and the values of the dataset are converted to count the incidence of the corresponding value for each. A sample of one-hot-encoding on a limited dataset is illustrated in Tables 2 and 3, below, where the values of the variable MCCs (Table 2) are encoded to be binary values (i.e., 0 or 1) in columns indicative of the separate MCCs (Table 3) (e.g., where 0 may represent no indication of bias for the given PAN and MCC, and where 1 may represent an indication of bias for the given PAN and MCC; etc.).

TABLE 2

| PAN | MCC |
|---|---|
| PAN_1 | 4121 |
| PAN_2 | 5814 |
| PAN_1 | 5814 |
| PAN_2 | 8041 |

TABLE 3

| PAN | 4121 | 5814 | 8041 | 5814 |
|---|---|---|---|---|
| PAN_1 | 1 | 0 | 0 | 0 |
| PAN_2 | 0 | 1 | 0 | 0 |
| PAN_1 | 0 | 0 | 0 | 1 |
| PAN_2 | 0 | 0 | 1 | 0 |

Further, Table 4 illustrates another example application of one-hot-encoding to a limited dataset to convert the dataset to a wide format. In Table 4, for each account number, example prefixes and suffixes are used (e.g., {Prod or MCC} _{XXX} _Decay_{Count, GrossDollarVal_0. {###}, etc.). As such, an example entry in Table 4 includes MCC_4121_Decay_GDV_0.075, which means the MCC is 4121 for Gross Dollar Transaction Values with a decay constant of 0.075. Another example entry in Table 4 includes PROD_BPD_Decay_Count_0.075, which means the product identifier is BPD for Transaction Counts with decay constant of 0.075. In this example application of one-hot-encoding, the values of the variable MCCs and variable products are again encoded (i.e., 0.0) in columns indicative of the separate MCCs and products (e.g., where 0.0 may represent no indication of bias for the given PAN and MCC/Product, and where other values may represent an indication of bias (e.g., a level of such bias, depending on the given numeric value, for example 0.1, 1.1, etc.; etc.) for the given PAN and MCC/Product; etc.).

TABLE 4

| | MCC_4121_{—} | MCC_5814_{—} | PROD_X#1_{—} | PROD_X#2_{—} |
|---|---|---|---|---|
| | Decay_GDV_{—} | Decay_GDV_{—} | Decay_Count_{—} | Decay_Count_{—} |
| de2_card_nbr | 0.075 | 0.075 | 0.075 | 0.075 |
| 2.227630E+18 | 0.0 | 0.0 | 0.0 | 0.0 |
| 2.227630E+18 | 0.0 | 0.0 | 0.0 | 0.0 |
| 2.227630E+18 | 0.0 | 0.0 | 0.0 | 0.0 |
| 2.227630E+18 | 0.0 | 0.0 | 0.0 | 0.0 |
| 2.227630E+18 | 0.0 | 0.0 | 0.0 | 0.0 |
| 2.227630E+18 | 0.0 | 0.0 | 0.0 | 0.0 |
| 2.227630E+18 | 0.0 | 0.0 | 0.0 | 0.0 |

By expanding the number of columns in the data set to define each value as a numeric value, it is apparent the dataset is converted to a wide format (e.g., potentially providing a more specific/granular/relative determination of bias (or potential bias), etc.). In addition, the assessment host 118 is configured to multiply the decayed counts and decayed gross-dollar-values, by the one-hot-encoded sub-data frame generated in the previous step. It should be appreciated that the encoding is not necessarily limited to one-hot-encoding, and that techniques may be employed to condition the data included in the dataset to be understood, or properly construed, by the model described below. Also, it should be appreciated that other engineered features of the dataset, as listed above, may be likewise encoded in the dataset, as necessary or desired, etc.

Finally, in preparing the dataset for modeling, the assessment host 118 is configured to aggregate the rows of the dataset by PAN, whereby each PAN is represented by only one row, with the values associated with the PAN, being summed or otherwise aggregated.

It should be appreciated that the dataset may (optionally) be further augmented with additional data through techniques such as, for example, clustering, normalization, logarithmic scaling, encoding, etc.

In one example, the assessment host 118 is configured to employ clustering, based on the topology data clustering approach, where the PANs are clustered based on the specific parameters, whereby each cluster is associated with a specific spending profile. The clustering of the PANs, together, may be indicated in the data set as a new data feature.

After the dataset is complete, the assessment host 118 is configured to separate the dataset into a training dataset, and a validation dataset. This may be accomplished by random selection of a percentage, or portion of the dataset to be preserved for the validation dataset, or based on any suitable technique, etc. In this example, the dataset is apportioned 80% into the training dataset and 20% into the validation dataset, yet other apportionments may be employed in other examples (e.g., 70/30, 90/10, etc.).

The assessment host 116 is then configured to train a binary classifier model, in this example, as it relates to the gender appended to the PANs. The classifier model may include, for example, logistic regression, decision trees, support vector machines (SVMs), and ensemble methods such as Random Forest or Gradient Boosting. However, in this example embodiment, the classifier model includes an Extreme Gradient Boosting or XGBoost model, which is designed to efficiently handle sparse and imbalanced data. In particular, in this example embodiment, the assessment host 118 is configured to train the XGBoost binary classifier model based on the training dataset with a minimum parameter tuning to prevent overfitting.

Once trained, the assessment host 118 is configured to then validate the trained classifier model, based on the validation dataset. The validation may include assessment of the Area Under the Curve (AUC), Precision, Recall, and F1-score, calculated by the assessment host 118. For example, AUC measures the performance of the trained classifier model across various classification thresholds and represents its ability to correctly classify male and female genders for the PANs, based on the selected features. A higher AUC value (closer to 1) indicates a better performing trained classifier model, whereas a lower value (closer to 0.5) implies that the trained classifier model is not much better than random guessing.

In addition to the AUC, the assessment host 118 may be configured to employ metrics, such as, for example, precision, recall, and F1-score. The metrics provide a comprehensive understanding of the trained classifier model's performance, which aids in identifying potential issues related to imbalanced classes or false predictions for bias.

It should be appreciated that the trained XGBoost classifier model may be further cross-validated against other models. For example, K-fold cross-validation may be employed, where the assessment host 118 is configured to divide the training dataset into ‘k’ equal parts or folds. The model is trained on k−1 folds and validation of the trained model on the remaining folds. The assessment host 118 is configured to repeat the training and validation k times, with each fold serving as the test set once. The final model performance, then, is obtained by the assessment host 118 by averaging the results of the k iterations. K-fold cross-validation may be employed, in this manner, to aid in mitigating potential bias and variance issues in the evaluation process.

Once the classifier model is trained and validated, the assessment host 118 is configured to delete the dataset, to thereby eliminate commingle of the demographic data and the financial data. The assessment host 118 is configured to then deploy the trained classifier model to other financial data, whereby the prediction of gender, in this example, or other demographics, in other examples, may be performed.

In this manner, the trained classifier model is configured to predict the gender or other demographic of a user of an account, based on a dataset of transaction data to the account, and independent of demographic data being included in that dataset. It should be appreciated that the trained classifier model may be employed for purposes of offers, marketing, fraud detection, program bias, etc., whereby understanding the demographics of users, or at least predicted demographics of users, is usable to plan strategies, take corrective action, etc.

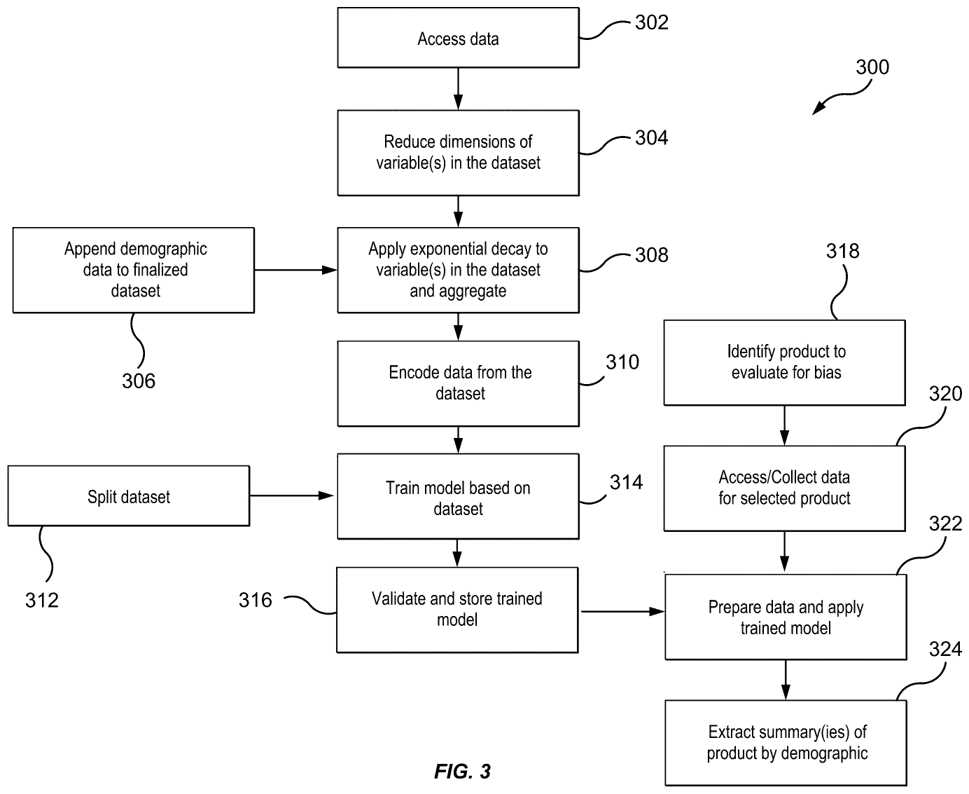

FIG. 3 illustrates an example method 300 for use in identifying bias in datasets, independent of certain data being included in the datasets. The method 300 is described with reference to the system 100, and in particular to the assessment host 118, and further with reference to the computing device 200. The methods described herein (including the method 300), however, should not be considered to be limited to the system 100, or the computing device 200. Likewise, the systems and devices herein should not be considered to be limited to the method 300.

At the outset, it should be appreciated that many users engage in network interactions (e.g., purchase transactions, etc.) with various merchants to purchase products. In connection therewith, a large volume of interaction data is generated, consistent with the description above, where the interaction data is representative of the interactions, on a per interaction basis. The volume of data may be 1 GB, 5 GB, 50 GB, 100 GB, or upwards of terabytes of data. The interaction data is stored in the data structure 120.

The interaction data, generally, is stored apart from demographic data for the users involved in or participating the network interactions.

At 302, the assessment host 118 accesses interaction data from the data structure 120, as a dataset. The dataset includes a defined interval of data, which, in this example embodiment, is three months. Consequently, for each interaction in the last three months, an entry is included in the dataset. The entry includes the account number, card present value, product type (e.g., type of account, etc.), MCC of the merchant involved in the interaction, amount (e.g., charge, tax, total, etc.), transaction count, person present, cashier present, online transaction, cross-border transaction, and other data indicative of the interaction, as necessary or desired, etc. Each different type of data in the dataset is a variable, whereby the MCC is a variable, the product type is a variable, etc.

It should be appreciated that the dataset may be accessed (or compiled) based on a different interval, or based on still other criteria. For example, the dataset may be limited to a specific geographic region, or to a particular product/account type, etc.

After the dataset is accessed, the assessment host 118 reduces, at 304, one or more of the variables included in the dataset, and in particular, reduces the values of the variables included therein. For example, the card present variable may include three different values, or more or less. In reducing the values, the assessment host 118 determines occurrence of the different values, and sets a threshold number of occurrences. For values that occur more than the threshold, the values are retained, while for values that occur less than the threshold, the assessment host 118 replaces the values with a common value (e.g., “other” or a new, unassigned numeric value, etc.). It should be appreciated that the threshold number of occurrences may be based on a percentage of the interactions (e.g., a ninety-fifth percentile, an eightieth percentile, etc.) or otherwise, etc.

Next, as shown in FIG. 3, the assessment host 118 appends demographic data to the dataset, at 306. The demographic data may include a gender, race, etc. Specifically, the assessment host 118 requests and/or retrieves (e.g., through an application programming interface (API), etc.), from the identity provider 110, identifying data and financial related data. The identifying data includes the demographic data for the users, and the financial related data links the demographic data to accounts of the users (e.g., the user 114, etc.). The assessment host 118 leverages the accounts to append the demographic data to each of the entries in the dataset.

It should be appreciated that the demographic data may be appended to the dataset, at a different time in the method 300, including, prior to step 304, or after step 308, etc.

Next, at 308, the assessment host 118 applies an exponential decay function, based on multiple constants, to the first variable of the dataset. In this example embodiment, the assessment host 118 applies the exponential decay to the transaction counts, and also the gross dollar values. That said, in other embodiments, the exponential decay may be applied to different variables of the dataset. Also, it should be appreciated that variants of the exponential decay may be employed along with other types of feature engineering to prepare the dataset (e.g., through averages, means, maximum, time series, day of year/week, season, etc.) to be used to train a classifier model.

In this example embodiment, the constants are each indicative of a different defined interval, such as explained above. That is, the defined intervals may each include a period of days, such as, for example, 30, 60, and 90 days, where the contents are 0.15, 0.075, and 0.005, respectively, etc.

In addition, at 308, the assessment host 118 aggregates certain data in the dataset (e.g., as generally described above with regard to the system 100, etc.). In particular, the assessment host 118 may group rows together by PAN (e.g., at the PAN level, etc.), and then add the associated values for the specific rows, leaving, separately, the product code (or card type), the MCC, and the card present data, etc. In this way, the various data for each PAN is generally reduced to one entry for the PAN. Optionally, as part of aggregating the date (or prior to or after), the assessment host 118 may append additional data to the dataset. The additional data may be identified from the listing of feature engineering example above and appended to the dataset.

At 310, the assessment host 118 encodes one or more variables in the dataset. For the interaction data, certain variables may include numerous values, which may be numeric, alpha-numeric, or alpha (e.g., words, etc.), etc. As such, encoding the variable(s) permit(s) a simplified value to be included in the dataset, albeit included in additional columns, for example.

In this example, encoding the second variable includes one-hot-encoding of the second variable, and the variable to be encoded includes MCC and/or product type. That is, for example, the product type may include numerous alpha codes, or abbreviations, such as, for example, MCG, OLR, MWE, MDJ, MAB, X #1, X #2, etc., each representative of a different product type. The assessment host 118, in encoding the variable product type, creates a column for each product type and populates a value (e.g., one, etc.) in the appropriate product type for the transaction. The same one-hot-encoding may be performed for other variables in the dataset. In addition, prior to encoding the variable(s), the assessment host 118 may reduce the MCC, or the product type, in this example, or other variables in the example, to eliminate limited occurrence values for the variable(s), and consequently, additional columns in the output dataset from the encoding.

With continued reference to FIG. 3, at 312, the assessment host 118 then splits the dataset into a training dataset and a validation training set. The dataset may be split based on a percentage, or a leave interval out techniques (e.g., leave two weeks out, etc.), whereby the split datasets are, generally, representative of the network interactions.

At 314, the assessment host 118 trains the XGBoost classifier model, in this example embodiment, based on the training dataset (for predicting demographics, etc.). In connection therewith, the XGBoost classifier model may utilize an example library such as ‘xgboost’ version 1.0.0.2 as available in R (statistical software), setting the following parameters: max_depth=6, eta=0.3, objective=binary: logistic, etc. Further, at 316, the assessment host 118 validates the trained XGBoost classifier model, as explained above, based on the validation dataset and stores the trained classifier model, based on the trained classifier model being validated. In addition, once validated, the assessment host 118 deletes the dataset to eliminate a common dataset with the interaction data and with the demographic data.

The trained classifier model is then prepared to be used to predict the demographics (e.g., gender, race, etc.) based on interaction data. With continued reference to method 300, to predict the demographics, the assessment host 118 initially identifies (or receives an input identifying, etc.), at 318, a desired product to evaluate for bias. The assessment host 118 then accesses/collects, at 320, target interaction data from the data structure 120 relating to the identified product, etc., as a target dataset (and consistent with operation 302 the above). In turn, the assessment host 118 proceeds to apply, at 322, the trained classifier model to the target dataset. In particular in this example, the assessment host 118 performs one or more of steps 304, 306, 308, 310 on the target dataset, to prepare the data set for application of the trained model, and then applies the trained model to the dataset. In this manner, the target dataset is prepared in the same manner as described above for the dataset from which the XGBoost classifier model was trained, yet without the labeled data (i.e., the demographics).

In connection therewith, the assessment host 118 applies the trained model to the target dataset to predict the demographics of the users involved in the interactions represented by the target interaction data (e.g., for the selected product, etc.). In this way, the prediction of the demographic(s) is based on the target dataset, which is devoid of demographic data, whereby the prediction is made independent of demographic data being included in the dataset (from which the prediction is made).

Then, at 324, in method 300, one or more summaries for the identified product (and corresponding data) are generated/extracted from the output of the trained model, for example, by demographic, and evaluated to determine potential bias (if any) in the data (and associated product).

Finally, the predicted demographics and interaction data may be analyzed to determine disparate activity, treatment, qualifications, etc., for the demographics. Human intervention may then be relied upon to review the finding and assess other factors related to the conclusion about business activities or actions associated with the disparate activity, treatment, qualifications, etc., whereby decisions may be made to alter the activities or actions to impact the disparate activity, treatment, qualifications, etc. For instance, input data may be altered to address and/or eliminate the indication of bias. Additionally, or alternatively, the identified product may not be used (or may be flagged) until any suggested bias is addressed and/or eliminated. Further, in some examples, the model may be evaluated for accuracy and revised/updated as needed to ensure any potential bias is addressed. Moreover, training may be implemented to increase awareness and development of best practices and policies to reduce (or remove) algorithmic bias (and/or potential impact resulting therefrom) and facilitate bias mitigation.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transforms a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by one or more of (a) accessing interaction data as a dataset, the interaction data being representative of multiple network interactions, the interaction data including a first variable and a second variable; (b) appending demographic data to the dataset; (c) applying an exponential decay function, based on multiple constants, to the first variable of the dataset, each of the constants indicative of a different defined interval; (d) encoding the second variable of the dataset into multiple columns in the dataset, each of the multiple columns including a binary value; (c) training a classifier model based on the dataset, where the demographic data defines classification of the interaction data; (f) storing the trained classifier model in memory; (g) accessing target interaction data as a target dataset, the target interaction data being representative of multiple target network interactions, the target dataset including the first variable and the second variable; (h) applying the exponential decay function, based on the multiple constants, to the first variable of the target dataset; (i) encoding the second variable of the target dataset into the multiple columns in the target dataset, each of the multiple columns including a binary value; and/or (j) applying the trained classifier model to the target dataset to predict target demographic data for the target dataset.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” “included with,” or “in communication with” another element or layer, it may be directly on, engaged, connected or coupled to, associated with, or in communication with the other element or layer, or intervening elements or layers may be present. As used herein, the term “and/or” includes any and all combinations of one or more of the associated listed items.

In addition, as used herein, a product may include a service, a good, etc.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in identifying content included in datasets, the method comprising:
accessing, by a computing device, interaction data as a dataset, the interaction data being representative of multiple network interactions, the interaction data including a first variable and a second variable;
appending, by the computing device, demographic data to the dataset;
applying, by the computing device, an exponential decay function, based on multiple constants, to the first variable of the dataset, each of the constants indicative of a different defined interval;
encoding, by the computing device, the second variable of the dataset into multiple columns in the dataset, each of the multiple columns including a binary value; and then
training, by the computing device, a classifier model based on the dataset, where the demographic data defines classification of the interaction data; and
storing the trained classifier model in memory.

2. The computer-implemented method of claim 1, wherein the multiple network interactions are between entities and users, where each of the multiple network interactions is funded by an account specific to one of the users involved in the network interaction;
wherein the interaction data includes account numbers for the accounts; and
wherein the demographic data is specific to the users.

3. The computer-implemented method of claim 1, wherein the interaction data includes a third variable; and
further comprising reducing the third variable based on a threshold number of occurrences of values in the third variable.

4. The computer-implemented method of claim 3, wherein the third variable includes a card present variable; and
wherein reducing the third variable includes converting values of the variable to a common value, when occurrence of the values is less than the threshold number of occurrences.

5. The computer-implemented method of claim 1, wherein the first variable includes at least one of a transaction count and a gross dollar value; and
wherein each of the defined intervals is a period of days.

6. The computer-implemented method of claim 1, wherein encoding the second variable includes one-hot-encoding of the second variable; and
wherein the second variable includes one or more of merchant category code (MCC) and product type.

7. The computer-implemented method of claim 6, further comprising reducing the second variable, prior to encoding the second variable.

8. The computer-implemented method of claim 1, wherein the classifier model is an Extreme Gradient Boosting (XGBoost) model.

9. The computer-implemented method of claim 8, further comprising splitting the dataset into a training dataset and a validation dataset; and
wherein training the classifier model includes training the classifier model on the training dataset; and
further comprising validating the trained classifier model based on the validation dataset; and
wherein storing the trained classifier model includes storing the trained classifier model in response to the trained classifier model being validated.

10. The computer-implemented method of claim 1, further comprising: deleting the dataset.

11. The computer-implemented method of claim 1, further comprising:
accessing, by the computing device, target interaction data as a target dataset, the target interaction data being representative of multiple target network interactions, the target dataset including the first variable and the second variable;
applying, by the computing device, the exponential decay function, based on the multiple constants, to the first variable of the target dataset;
encoding, by the computing device, the second variable of the target dataset into the multiple columns in the target dataset, each of the multiple columns including a binary value; and then
applying the trained classifier model to the target dataset to predict target demographic data for the target dataset; and
wherein the target demographic data includes at least one of a gender and a race for each user involved in each of the multiple target network interactions.

12. A system for use in identifying content of datasets, the system comprising:
a memory including interaction data and demographic data, the interaction data being representative of multiple interactions; and
an assessment host computing device coupled to the memory and configured to:
access interaction data as a dataset, the interaction data being representative of multiple network interactions, the interaction data including a first variable and a second variable;
append demographic data to the dataset;
apply an exponential decay function, based on multiple constants, to the first variable of the dataset, each of the constants indicative of a different defined interval;
encode the second variable of the dataset into multiple columns in the dataset, each of the multiple columns including a binary value; and then
train and store, in the memory, a classifier model based on the dataset, where the demographic data defines classification of the interaction data.

13. The system of claim 12, wherein the multiple network interactions are between entities and users, where each of the multiple network interactions is funded by an account specific to one of the users involved in the network interaction;
wherein the interaction data includes account numbers for the accounts; and
wherein the demographic data is specific to the users.

14. The system of claim 12, wherein the interaction data includes a third variable; and
wherein the assessment host computing device is further configured to reduce the third variable based on a threshold number of occurrences of values in the third variable.

15. The system of claim 14, wherein the third variable includes a card present variable; and
wherein the assessment host computing device is configured, in order to reduce the third variable, to determine that occurrence of the values is less than the threshold number of occurrences and then convert values of the variable to a common value.

16. The system of claim 12, wherein the assessment host computing device is configured, in order to encode the second variable, to apply one-hot-encoding to the second variable; and
wherein the second variable includes one or more of merchant category code (MCC) and product type.

17. The system of claim 16, wherein the assessment host computing device is further configured to reduce the second variable, prior to encoding the second variable.

18. The system of claim 12, wherein the assessment host computing device is further configured to delete the dataset.

19. The system of claim 12, wherein the assessment host computing device is further configured to:
access interaction data as a target dataset, the target interaction data being representative of multiple target network interactions, the target dataset including the first variable and the second variable;
apply the exponential decay function, based on the multiple constants, to the first variable of the target dataset;
encode the second variable of the target dataset into the multiple columns in the target dataset, each of the multiple columns including a binary value; and then
apply the trained classifier model to the target dataset to predict target demographic data for the target dataset;
wherein the target demographic data includes at least one of a gender and a race for each user involved in each of the multiple target network interactions.

20. A non-transitory computer-readable storage medium including executable instructions for use in identifying content of datasets, which when executed by at least one processor, cause the at least one processor to:
access interaction data as a dataset, the interaction data being representative of multiple network interactions, the interaction data including a first variable and a second variable;
append demographic data to the dataset;
apply an exponential decay function, based on multiple constants, to the first variable of the dataset, each of the constants indicative of a different defined interval;
encode the second variable of the dataset into multiple columns in the dataset, each of the multiple columns including a binary value; and then
train a classifier model based on the dataset, where the demographic data defines classification of the interaction data; and
store the trained classifier model in memory.
